(19) United States
(12) Patent Application Publication
(10) Pub. No.: US 2005/0127761 A1
(43) Pub. Date: Jun. 16, 2005

(54) Axial gap type single-phase brushless motor

(75) Inventor: Tetsushi Yashima, Isesaki-shi (JP)

Correspondence Address: JORDAN AND HAMBURG LLP, 122 EAST 42ND STREET, SUITE 4000, NEW YORK, NY, 10168, US

(73) Assignee: Tokyo Parts Industrial Co., Ltd.

(21) Appl. No.: 10/973,884

(22) Filed: Oct. 26, 2004

(30) Foreign Application Priority Data
Oct. 28, 2003 (JP) 2003-366763

(51) Int. Cl. H02K 5/24; H02K 7/00; H02K 11/00

(52) U.S. Cl. 310/51; 310/181

(57) ABSTRACT

By using a small cogging torque generation means, having a simple, thin and small constitution that can maintain strength and cause a rotor to stably stop at a prescribed position. An axial air-gap single phase brushless motor wherein a rotor having a magnet with six pole pieces is rotatably supported by a stator comprising a pair of air-core coils disposed on a base, wherein, in a core portion of one of the pair of air-core coils, a magnetic piece with a length roughly half the circumferential length is attached to the side of a reference line opposite the direction of rotation and parallel with said bracket, and a hole sensor is provided on a reference line that passes through the center of rotation and forms rights angles with the reference line.

### BACKGROUND OF THE INVENTION

1. Field of the Invention

The present invention relates to a single-phase brushless motor having a hole sensor incorporated therein as a position detector element. More specifically, it relates to an axial air-gap single-phase brushless motor that while being thin and miniaturized has a simple construction and is capable of reliably stopping a rotor at a position enabling self-starting.

2. Description of the Prior Art

A single-phase brushless motor needs only one position detection element, and its drive circuit is relatively simple and inexpensive. Thus these motors are frequently used in fan motors, and as miniaturization has progressed they have also come to be used in vibration motors.

The following documents disclose single-phase brushless motors used in fan motors: Japanese Laid-open Utility Model Application 59-138378 and its divisional application, Japanese Laid-open Utility Model Application 62-135568, Japanese Laid-open Utility Model Application 60-177670, and Japanese Laid-open Utility Model Application 60-119884.

In the case of a single-phase brushless motor, in a construction for self-starting, the positional relationship among the effective conductor part of the coil, the hole sensor and the cogging torque generation member for stopping the rotor is important. The above documents all disclose this positional relationship and have constructions such that all the elements are disposed in such a manner that the motor self-starts without any problem Japanese Laid-open Utility Model Application 59-138378 discloses a construction such that a screw head serving as the cogging torque generation member is attached so as to project to the coil side of a stator, and such screw is fixed to the yoke and case below the coil.

Japanese Laid-open Patent Applications 2003-88805 and 2003-88807 disclose a construction for a single-phase brushless motor used as a vibration motor.

These documents disclose a construction wherein a flat cogging torque generation member that also serves as a yoke for an air-core coil is integrated with a stator using resin, and the drive circuit is integrated and incorporated into the motor main body.
Patent document 1: Japanese Laid-open Utility Model Application 59-138378
Patent document 2: Japanese Laid-open Utility Model Application 61-7280
Patent document 3: Japanese Laid-open Utility Model Application 62-135568
Patent document 4: Japanese Laid-open Utility Model Application 60-177670
Patent document 5: Japanese Laid-open Utility Model Application 60-119884
Patent document 6: Japanese Laid-open Utility Model Application 59-1388378
Patent document 7: Japanese Laid-open Patent Application 2003-88805
Patent document 8: Japanese Laid-open Patent Application 2003-88807

To have a rotor reliably stop at a predetermined position to enable self-starting of a single-phase brushless motor, it is necessary that a magnet attached to the rotor at the stop position be magnetically stable, as is described in the above documents.

For this purpose, as in documents 1 and 2, the projecting part of a magnetic body serving as a cogging torque generation member is constituted by the head of a screw, forming a magnetic path together with a yoke below the coil. With such a construction, the projecting part of the magnetic body receives the magnetic flux from the magnet and stably stops the rotor.

In the other cited documents, a yoke plate cutaway part serving as a cogging torque generation means receives the magnetic flux from a strongly magnetic part of the magnet, stably stopping the rotor.

### DISCLOSURE OF THE INVENTION

Problems the Invention Aims to Solve

With such constructions, while there is the advantage that the rotor is stably stopped, there is the problem that the configurations for the cogging torque generation member become large, making miniaturization of the motor difficult.

In a construction as set forth in document 1, the yoke and case are fixed by means of a screw, and the screw is used as the cogging torque generation means. Therefore, the number of parts increases and it becomes difficult to miniaturize the motor in the thickness direction.

In addition, in the other constructions, because a yoke plate provided beneath the coil serves as a cogging torque generation member, a relatively large cogging torque generation member becomes necessary, making it difficult to miniaturize a motor, or to keep a motor inexpensive.

A further problem is that, because the primary object of these constructions is to cause a rotor to stop, the cogging torque becomes large, a large starting torque is required, and the starting current becomes large.

The object of the present invention is to provide an axial air gap single-phase brushless motor that solves the above problems, has a simple construction, is flat and miniaturized and, though miniaturized, is strong and can stably stop a rotor at a predetermined position.

### SUMMARY OF THE INVENTION

Means for Solving the Problems

In order to resolve the aforementioned problems, a construction as set forth in claim 1 is provided for an axial air gap single-phase brushless motor, comprising a stator having a printed circuit board on which a pair of single-phase connected air-core coils are disposed concentrically on a predetermined reference line extending from the motor rotation center in the diametrical direction and a rotor rotatably supported thereupon opposite the coils with an axial air gap therebetween, wherein the rotor comprises an axial air gap magnet having six pole pieces and a yoke that forms a magnetic path for the magnet and causes the magnetic flux of the magnet to operate on the air-core coils, the angle opening of the effective conductor part of the pair of air-core coils being 60 degrees. Within the air core portion of one of these coils a magnetic cogging torque generation member that is roughly half the length of the peripheral direction of the air-core portion is attached parallel with the bracket on the side of the reference line opposite from the rotor rotation direction, and a hole sensor is provided on another reference line on the printed circuit board that passes through the center of rotation of the rotor and forms right angles with the reference line.

With such a construction, the cogging torque generation member uses a length that is roughly half the length of the air-core coil to magnetically position in a stable state a neutral part of the magnet at a position displaced only the necessary degrees from the coil effective conductor part, reliably causing the rotor to stop in a state enabling self-starting. At such time the hole sensor is not positioned at a neutral part of the magnet.

Even with such a construction where a rotor is reliably stopped, a small cogging torque generation means is sufficient, the cogging torque generation means being accommodated within an air-core coil, and a thin plate is used for a bracket, meaning that miniaturization of the overall motor is possible. Further, despite being small overall the structure is strong.

Further, with the construction of claim 1, the hole sensor and coils do not overlap, allowing the motor to be made thin and miniaturized.

In the construction of claim 2, the stator is constructed so that the printed circuit board is attached to a flat part of a bracket formed from a non-magnetic or weakly magnetic plate, a case made from a non-magnetic or weakly magnetic plate is attached to the bracket so as to cover the rotor, and said cogging torque generation means is more magnetic than the bracket; with such a constitution, despite the fact that the motor is made thin and miniaturized, the motor can be made strong.

In the construction of claim 3, the cogging torque generation member is plate shaped, and if the flat surface is attached parallel with the bracket, the magnetic flux of adjacent pole pieces of the magnet is reliably captured, and a neutral part of the magnet is reliably stopped at the center of the cogging torque generation member.

In the construction of claim 4, an opening is provided in the printed circuit board, and the cogging torque generation member is disposed within that opening; this facilitates the positioning of the cogging torque generation member and the distance with the magnet can be adjusted.

### EFFECTS OF THE INVENTION

In accordance with the present invention, the cogging torque generation member generates cogging torque by receiving magnetic flux going from an N pole piece to an S pole piece or an S pole piece to an N pole piece, such pole pieces being adjacent, at a neutral position of the rotor magnet. Therefore, there is no need to otherwise form a magnetic path. Further, by using a thin plate that is more magnetic than the bracket, magnetic flux is received from adjacent pole pieces.

Thus in accordance with the present invention, a motor can be miniaturized, with a simple and inexpensive construction.

Because there is a single cogging torque generation means that generates cogging torque, it can be disposed within the air-core formed in the inner diameter of a coil, and because the inner diameter of a coil can be used as a guide for disposition and position control, the rotor stop position can be reliably made an effective position with respect to the hole sensor and coil effective conductor part.

Further, because the bracket can be constituted from a thin non-magnetic or weakly magnetic metal plate and because the cogging torque generation means is also small, the motor overall can be miniaturized, and by assembling the bracket with a case made from a similar metal plate the motor can have good strength.

### BRIEF DESCRIPTION OF THE DRAWINGS

FIG. 1 is a lateral cross-sectional view (along the A-A line in FIG. 2) of an axial air gap single-phase brushless motor according to the present invention used as a vibration motor.

FIG. 2 is a plan view of the single-phase brushless motor shown in FIG. 1, showing a stator.

FIG. 3 is a plan view of a rotor used in this single-phase brushless motor, showing a rotor as seen from the stator.

FIG. 4 is a lateral cross-sectional view of a second embodiment of an axial air gap single-phase brushless motor according to the present invention used as a vibration motor.

### DETAILED DESCRIPTION OF THE PREFERRED EMBODIMENTS

This axial air gap single-phase brushless motor comprises a stator S, a rotor R rotatably supported on the stator S, and a cover 3 attached to a bracket 1 of the stator S and covering the rotor R.

A base 2 comprising a printed circuit board is attached to the bracket 1, and attached onto this base 2 are air-core coils 6A, 6B, which are single-phase connected at a predetermined position on the base 2, a hole sensor 7 and an IC for drive 8.

A magnetic piece 9, which is a cogging torque generation member, is disposed within the air core part 6C, which is the inner diameter part, air-core part of the air-core coil 6A, so as to be eccentric in the direction opposite the rotor R rotation direction.

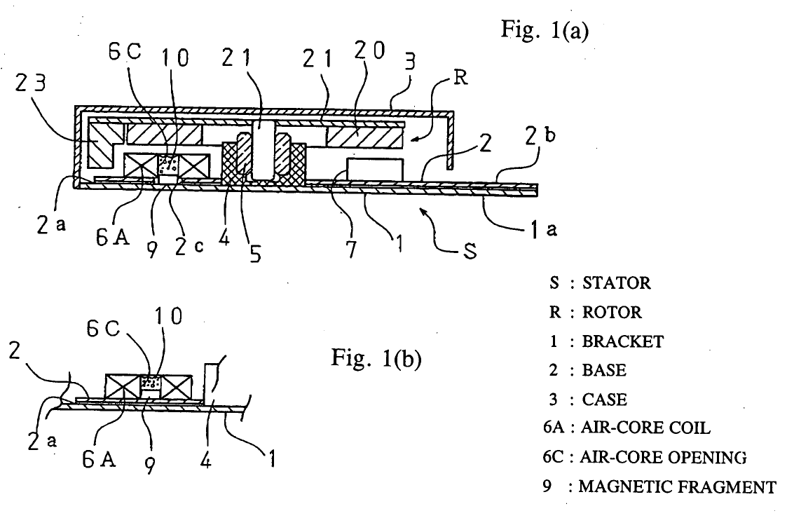

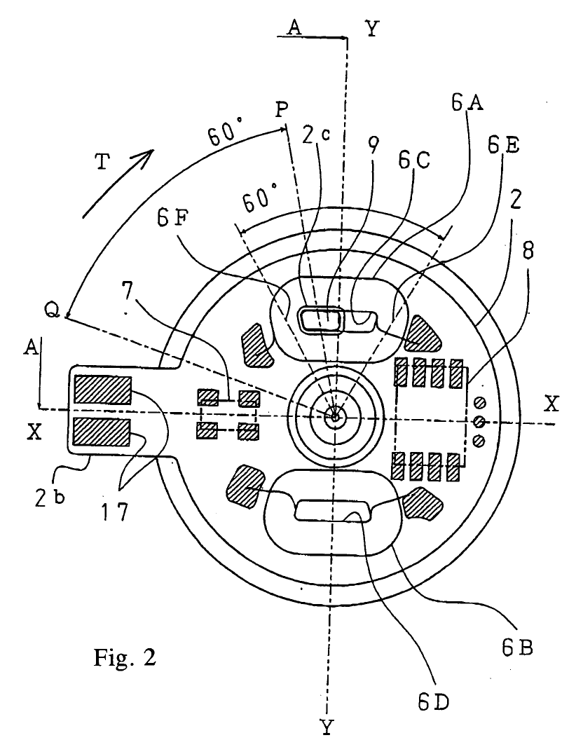

A detailed explanation will be given based on the figures. In the description of the embodiments below, the up and down and left and right directions refer to such directions as seen in FIGS. 1 and 2.

### First Embodiment

The stator S comprises a bracket 1, a base 2 and an air-core coil 6 and the like attached to the top of the base 2.

The bracket 1 is formed from a roughly circular plate material of, for example, non-magnetic thin stainless steel, one end of which extends in the radial direction to form a terminal support part 1a. Non-magnetic SUS304 is used as the material. So that the motor will have a thickness between 2 and 3 millimeters, a plate with a thickness of between 0.15 to 0.2 millimeters is used.

To maintain its strength, the bracket 1 is formed in a flat plate shape, with a partial opening for outsert molding provided. However, to increase the strength, or else for reasons of assembly with the case 3, there maybe cases where a step portion will be formed by contraction of the annular shape of the outer periphery.

In the center of the bracket 1 a resin bearing holder 4 formed by outsert molding is formed for the purpose of holding a bearing 5 made, for example, of a sintered oil-containing metal.

On the upper surface of the bracket 1 the base 2 is attached with an adhesive sheet 2a or other adhesive. The base 2 is a printed circuit board made from a glass epoxy resin or a flexible material and formed into a circular shape; one end thereof extends in the radial direction forming a power supply terminal 2b supported by the terminal support part 1a.

On the base 2, the air-core coils 6A and 6B are attached upon a reference line Y that passes through the center of rotation, said coils being disposed at concentric positions opposing each other at 180 degrees so as to be symmetrical along the reference line Y. In this embodiment, because a magnet constituting a rotor R (described below) has six pole pieces, the angle opening of effective conductor parts 6E and 6F is 60 degrees.

The air-core coils 6A and 6B have air-core parts 6C and 6D having oval shapes with the long axis in the circumferential direction. For these air-core parts 6C and 6D, the portion that is to become the core when wires are wound to form the coil will be disposed so as to be symmetrical along the reference line Y.

These core portions may be a variety of shapes, including oval, ellipse, and polygon.

Also attached to this base 2 is a hole sensor 7 and a drive IC 8. The hole sensor 7 is disposed on the right-hand side of a reference line X that is orthogonal to the reference line Y, and the drive IC 8 is disposed on the left-hand side thereof.

The air-core coils 6A, 6B, hole sensor 7 and drive IC 8 are connected by predetermined lands and patterns, and power is supplied from power supply lands 17. These lands are indicated in FIG. 2 with shading, and a detailed description thereofwill be omitted. Effective conductor parts 6E and 6F of the air-core coils and the hole sensor 7 are disposed concentrically; the constructions thereof being well-known constructions and explanation thereof will be omitted.

A magnetic piece 9 is disposed on the left side of the reference line Y in the air-core part 6C. This magnetic piece 9 is formed from a strongly magnetic plate material, and the outer diameter thereof has roughly the same shape as the left-hand side of the air-core part 6C, and the outer diameter is made slightly smaller. For the strongly magnetic material, an SUS430 stainless steel plate or a silicon steel plate is used. The length thereof is roughly the same as half the length of the long axis of the air-core part 6C.

While thickness of the plate material will depend on the size of the desired cogging torque, a thickness from 0.15 to 0.3 millimeters will be used.

Above, the material used for the bracket 1 was non-magnetic SUS304. Thus because the bracket 1 does not form a magnetic path, the places where the magnetic piece 9 causes cogging torque are clearly defined so that the rotor R is reliably stopped.

The bracket 1 maybe formed from a weakly magnetic material such as SUS302-½H-CSP. In such a case a material having a stronger magnetism, such as a silicon steel plate, is used for the magnetic piece 9. In such a case, however, cogging torque increases, and the starting torque increases in turn, meaning that a comparatively large current is needed for starting.

At a position on the base 2 where the magnetic piece 9 is to be disposed, an opening 2c is provided that is slightly bigger than the magnetic piece 9. Because this is for clearly marking the position where the magnetic piece 9 is to be disposed, the magnetic piece 9 is directly placed on the bracket 1.

To clearly delineate the position where the magnetic piece 9 is to be disposed, a mark may be placed using a resist, dummy pattern or the like on such position on the base 2. In such a case, as shown in FIG. 1(b), the magnetic piece 9 is placed on the base 2, and the distance from the rotor R shortens.

Further, the opening 2c as shown in FIG. 1(a) is an opening that extends through the adhesive sheet 2a. By making an opening only in the printed circuit board portion, the remaining adhesive paper will serve to temporarily fix the magnetic piece 9.

In this manner the opening 2c is used for such purposes as positioning, adjusting the height of, or temporarily fixing the magnetic piece 9.

After the magnetic piece 9 is disposed in the air-core part 6C, it is fixed therein with, for example, a UV-ray cured adhesive resin 10. A UV-ray cured adhesive resin has low viscosity prior to curing, but because it is applied within the air-core part it does not flow to other locations.

The rotor R comprises an axial air gap magnet 20 magnetized to have six pole pieces alternating between north and south in the circumferential direction, a yoke 21, an arc-shaped weight 23 fixed to the yoke 21 on an outer portion in the radial direction of the magnet 20, and a rotary shaft 22 fixed to the yoke 21 and serving as the center of rotation for the rotor R.

The yoke 21 forms a magnetic path for the magnet 20 and transmits the magnetic force from the magnet 20 to the air-core coils 6A and 6B.

The angle of opening for the magnetized pole pieces is 60 degrees, and between adjacent pole pieces there is a slight unmagnetized portion, namely, a neutral piece 20a. These neutral pieces 20a are also formed in six places at 60 degree intervals.

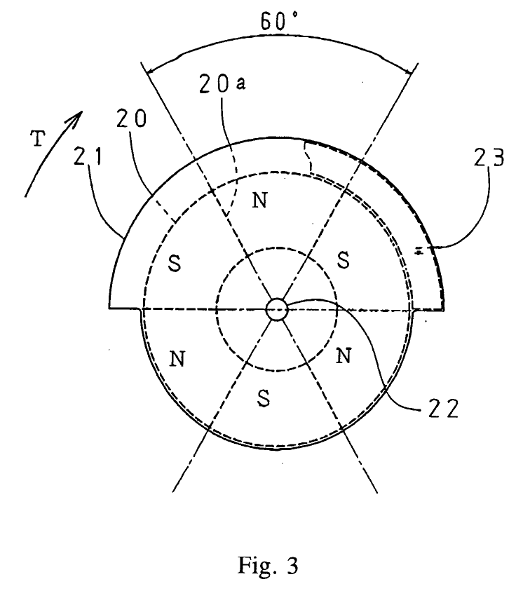

FIG. 3 is a plan view of the rotor R seen from the case 3 side, with rotation in the direction of the arrow T in the case of the invention of the present application.

The bottom edge of the cap-shaped case 3 is fixed by welding or the like to the outer periphery of the bracket 1. The case 3 is also formed from a non-magnetic stainless steel sheet such as SUS304, and is constituted in a manner to maintain the strength of the motor overall.

The case 3 has a cylindrical cap shape and is made of the same material as the bracket. Overall strength is improved when the downward-opening side is fixed to the outer periphery of the bracket 1 by welding or other means.

The operations of an axial air gap single-phase brushless motor thus constituted will now be explained.

As can be seen from FIG. 2, the magnetic piece 9 serving as cogging torque generation means is disposed to the left of the reference line Y and has a length that is half that of the air-core part 6C. This length is longer than a neutral piece 20a of the magnet 20. The magnetic piece 9 is flat and disposed parallel to the surface direction of the bracket 1, and does not form a magnetic path with any other member. For this reason, when drive torque does not act on the rotor, a neutral part 20a stably stops at a central location of the magnetic piece 9 (the position designated by the line P). In other words, the magnetic piece 9 is disposed so as to receive the magnetic flux from adjacent magnetized pole pieces.

Because the left-hand edge of the magnetic piece 9 is guided by and disposed in the left-hand side of the air-core 6C, the neutral part 20a will not come above the effective conductor part 6F. In addition, because the length of the magnetic piece 9 is roughly half that of the air-core part 6C, the neutral part 20a will not overlap the reference line Y.

At this time, as can be seen from FIG. 2, because the hole sensor 7 is above the reference line X which is orthogonal to the reference line Y, a neutral part 20a (at the position indicated by line Q) will not come to the position of the hole sensor 7.

With such a positional relationship among the elements, when current flows to the air-core coils 6A and 6B so as to cause the rotor to rotate toward the right (the direction indicated by the arrow T), because the effective conductor part 6F and the hole sensor 7 are both within the magnetic flux, the rotor R rotates and the motor self starts.

Further, the effective conductor part 6F and the hole sensor 7 are positioned between the neutral part 20a and the most magnetic part of the magnetized pole piece in the direction of rotation, ensuring self-starting.

If the length of the magnetic piece 9 is made to exceed half the length of the air-core part 2C the stop position of the neutral part 20a gradually approaches the reference line Y. Therefore, it is preferable that the length of the magnetic piece 9 be no greater than ¾ the length of the air-core part 2C, more preferably roughly half.

The above explanation pertains to an axial rotation motor having the construction of FIGS. 1 through 3. The present invention may also be applied to a fixed shaft motor used in recent years as a vibration motor. In this case, it is not a bearing that is fixed in the bearing holder 4, but a shaft, and instead of a rotary shaft 22, a bearing is attached to the rotor. Alternatively, the bearing holder 4 can be constructed by a burring hole arising from the bracket.

With respect to the rotor, too, the above embodiment presumes a rotor for a vibration motor having a weight 23. It goes without saying, however, that the rotor may be used for a fan motor or a standard brushless motor.

Further, the magnetic piece 9 is not limited to sheet material. Any bar-shaped material having a length the same diameter and roughly half the width of the air-core part 6C may be used. In such a case, the bar is disposed so that its axial direction is parallel with the bracket.

### Second Embodiment

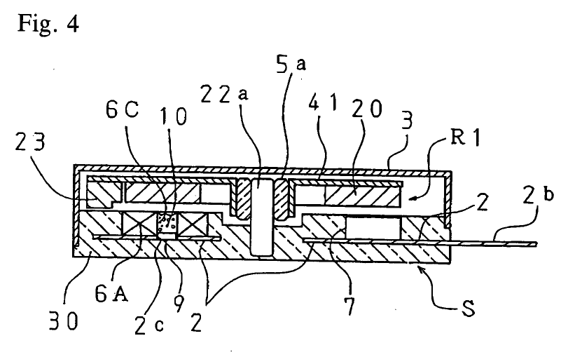

FIG. 4 shows an embodiment of the present invention in which a stator is a fixed-shaft type and is formed from a resin.

Explanation will be omitted for elements having the same reference number and demonstrating the same effect as in the first embodiment.

A stator S1 is unitarily molded with the base 2, air-core coils 6A, 6B, hole sensor 7 and drive IC 8 using a resin 30.

The shaft 22a is also unitarily molded from the resin 30 as part of the stator S1. It supports a rotor R1 rotatably with respect to the stator S1 via a bearing 5a fixed to a yoke 41 of the rotor R1.

The magnetic piece 9 is disposed on the resin 30 at the position of an opening 2c on the base 2 and is fixed thereto by a UV-ray cured resin 10.

Because the magnetic piece 9 itself generates detent torque, it can stop the rotor at a prescribed position even though the stator is made from resin.

Further, in the above explanation, the rotation direction of the rotor R (the direction indicated by arrow T) is to the right. If this is made to the left (the direction opposite that indicated by arrow T), the magnetic piece 9 should be disposed on the right side of the reference line Y in the air-core part 6C.

When the magnetic piece 9 is disposed in air-core part 6D within air-core coil 6B, it should be disposed in a position that is point-symmetrical, centering on the rotary shaft, with respect to the explanation above.

The above embodiment addressed a case where the plate-shaped cogging torque generation member is parallel with the surface of the bracket. It is also conceivable that a similar member be disposed within an air-core part in an upright state with respect to the bracket surface.

In such a case, it is not a neutral part of the magnet, but the most highly magnetized part that stops so as to be at the position of the cogging torque generation means. This is because the surface area of the cogging torque generation means that is opposite the magnet is small, and the orthogonal direction with respect to the magnet surface is long, resulting in stabilization in the direction of strong magnetic flux.

In such a case, the cogging torque generation means is disposed on the rotation direction side of the reference line Y, that is, on the right side of the air-core part 6C when the rotor rotates in the direction indicated by the arrow T. By making the disposition position the reverse with respect to the reference line Y, the same effects as set forth above are obtained.

1. An axial air gap single-phase brushless motor comprising a stator having a printed circuit board on which a pair of single-phase connected air-core coils and a rotor rotatably supported by such stator and opposing said coils with a gap in the axially direction therebetween, wherein said rotor comprises an axial air gap magnet having six pole pieces and a yoke that applies the magnetic flux of the magnet on the air-core coils, said pair of air-core coils have an effective conductor part angle opening of 60 degrees and are disposed on a prescribed reference line extending in the diametrical direction from the center of rotation of said rotor, within the air core portion of one of these coils a magnetic cogging torque generation member that is roughly half the length of the air-core portion in the circumferential direction is attached parallel with said bracket on the side of the reference line that is opposite the rotor rotation direction, and a hole sensor is provided on another reference line on said printed circuit board that passes through the center of rotation of said rotor and forms right angles with said reference line.

2. An axial air gap single-phase brushless motor according to claim 1, wherein said stator is constituted so that the printed circuit board is attached to a flat part of a bracket formed from a non-magnetic or weakly magnetic sheet and a case made from a non-magnetic or weakly magnetic case is attached to the bracket so as to cover the rotor, and said cogging torque generation means is more magnetic than the bracket.

3. An axial air gap single-phase brushless motor according to claim 1, wherein a cogging torque generation member is sheet shaped and its flat surface is attached parallel with the bracket.

4. An axial air gap single-phase brushless motor according to claim 1, wherein an opening is provided in the printed circuit board, and cogging torque generation means is disposed within that opening.
